(19) United States
(12) Patent Application Publication
(10) Pub. No.: US 2019/0025953 A1
(43) Pub. Date: Jan. 24, 2019

(54) FORMING TOUCH SENSOR ON FABRIC

(71) Applicant: Microsoft Technology Licensing, LLC, Redmond, WA (US)

(72) Inventors: Siyuan MA, Redmond, WA (US); Benjamin SULLIVAN, Seattle, WA (US); Kelly Marie BOGAN, Redmond, WA (US); James David HOLBERY, Bellevue, WA (US)

(73) Assignee: Microsoft Technology Licensing, LLC, Redmond, WA (US)

(21) Appl. No.: 15/658,224

(22) Filed: Jul. 24, 2017

(51) Int. Cl. G06F 3/041; D03D 15/00; A41D 20/00; G06F 1/16; B32B 5/02; B32B 7/12; B32B 37/12; B32B 27/06

(52) U.S. Cl. CPC G06F 3/041; D03D 15/00; A41D 20/00; G06F 1/1637; B32B 5/024; B32B 7/12; B32B 2457/00; B32B 27/06; G06F 2203/04104; G06F 2203/04103; B32B 2255/26; B32B 2255/02; B32B 37/12

(57) ABSTRACT

Examples are disclosed that relate to touch sensors formed on fabrics. One example provides a touch sensor including a fabric layer, a first electrode having a conductive ink disposed on the fabric layer, a dielectric structure disposed over the first electrode, the dielectric structure including an electrode support layer and an adhesive layer bonding the electrode support layer to the fabric layer and the first electrode, and the touch sensor also including a second electrode disposed on the electrode support layer.

### BACKGROUND

Touch sensors may be configured to detect touch via a variety of methods, including but not limited to capacitive methods. Touch sensors are commonly used as user input mechanisms for computing devices.

### SUMMARY

Examples are disclosed that relate to touch sensors formed on fabrics. One example provides a touch sensor including a fabric layer, a first electrode having a conductive ink disposed on the fabric layer, a dielectric structure disposed over the first electrode, the dielectric structure including an electrode support layer and an adhesive layer bonding the electrode support layer to the fabric layer and the first electrode, and the touch sensor also including a second electrode disposed on the electrode support layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B schematically depict an example computing device comprising touch sensors.

FIG. 2 schematically shows a schematic sectional view of an example touch sensor.

FIG. 3 shows an example wearable device comprising a touch sensor.

FIG. 4 shows another example wearable device comprising a touch sensor.

FIG. 5 shows yet another example wearable device comprising a touch sensor.

FIG. 6 shows an example furniture item comprising a touch sensor.

FIG. 7 shows a flowchart illustrating an example method of forming a touch sensor.

FIG. 8 shows a block diagram showing an example computing device.

### DETAILED DESCRIPTION

Touch sensors generally take the form of a sensing array integrated into a rigid surface, which may or may not be transparent, depending upon the implementation. However, rigid touch sensors may not be suitable for incorporating into soft-touch items, such as fabric items, as the rigid touch sensors may negatively impact feel and/or functionality of a soft-touch item.

To incorporate a touch sensor into a fabric item, layers of touch-sensing materials may be formed directly on the fabric. However, the structure of the fibers used to make fabrics and the porous, uneven surface morphology of fabrics may present challenges. For example, the fibers of the fabric may absorb the materials used for forming electrodes (e.g. conductive inks) of the touch sensor. This may make the deposition of thin, even layers of an electrode material challenging. Such absorption may be avoided by forming or adhering a substrate material to the fabric and then printing the electrodes on the substrate material, but the additional substrate layer may add undesired thickness to the touch sensor, and involves additional manufacturing steps.

Further, the porous surface morphology may present challenges in forming a dielectric layer between electrodes. For example, where the dielectric layer is deposited as a resin, the pores may provide locations for the formation of openings through the dielectric layer, which may pose a risk of shorting between electrode layers. Such a risk may be mitigated by depositing a thicker dielectric layer, but the thicker layer may negatively impact the feel of an item incorporating the touch sensor. Also, in some devices, such a surface morphology may lead to defects that can result in the formation of cracks in the dielectric layer as the fabric flexes.

Accordingly, examples are disclosed that relate to touch sensors formed on fabric that may address such issues. Briefly, the disclosed examples provide touch sensors comprising an electrode layer formed directly on the fabric and a dielectric structure laminated over the electrode layer via an adhesive. Such a structure may allow the use of a thin and smooth dielectric layer that avoids the shorting risks described above. Further, the fabric may be formed from a coated fiber, or may otherwise comprise a coating, that may help to lessen the absorption of conductive inks used to print electrodes on the fabric and/or decrease a roughness of the fabric.

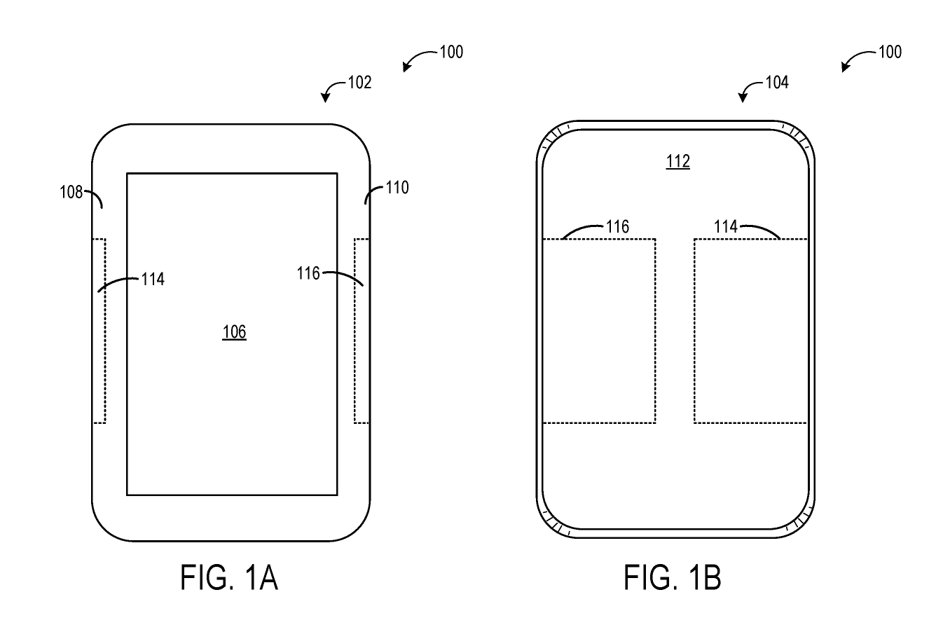

A touch sensor formed on fabric may be used in many different types of devices. FIGS. 1A and 1B illustrate an example of a hand-held computing device 100 in the form of a tablet computing device. FIG. 1A shows a front view 102 of the hand-held computing device 100 and FIG. 1B shows a back view 104. The hand-held computing device 100 includes a display 106. Various surfaces of the hand-held computing device 100 may be formed from a fabric material, such as front side surfaces 108 and 110, and a back surface 112.

One or more touch sensors as disclosed herein may be incorporated into one or more locations of the soft exterior surfaces. In the example of FIG. 1A, a first touch sensor 114 may be incorporated in the material of the first side surface 108 and a second touch sensor 116 may be incorporated in the material of second side surface 110. As depicted, the first touch sensor 114 and the second touch sensor 116 may each extend across the back surface 112 of the hand-held computing device 100 and wrap around the sides of the hand-held computing device 100. In this example, the first touch sensor 114 may serve as a left-hand touch sensor, while the second touch sensor 116 may serve as a right-hand touch sensor. In other examples, one or more touch sensors may have any other suitable placement.

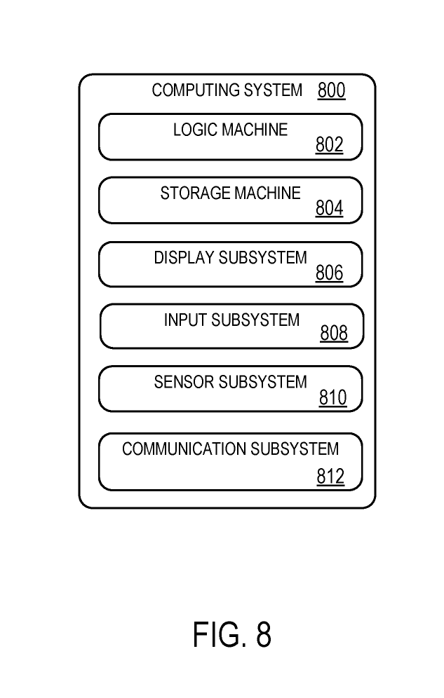

The first touch sensor 114 and second touch sensor 116 are each configured to detect touches and touch gestures and thereby provide a tactile interface to hand-held computing device 100. Each touch sensor may include an array of sensing elements, each sensing element configured to detect a signal via an intersection between a first conductive electrode and a second conductive electrode. The tactile interface provided by the first and second touch sensors 114, 116 may be in addition to a tactile interface provided by a touch-sensitive screen incorporated with the display 106. In such an example, various touch-based input gestures may be used for user interface interactions, e.g. to perform a selection operation in place of or in addition to a touch screen input. This may allow touch-based user inputs to be made without requiring a user to release a grip of the hand-held computing device 100 to use the touch screen, and may also allow a greater variety of user inputs to be made. The hand-held computing device 100 may include a logic machine including a processor and a storage machine including memory storing instructions executable by the processor to monitor the outputs of the touch sensors for such interactions, and to perform an action on the hand-held computing device 100 responsive to a touch-based input detected by one or more of the touch sensors. More details on an example computing system are described below with reference to FIG. 8.

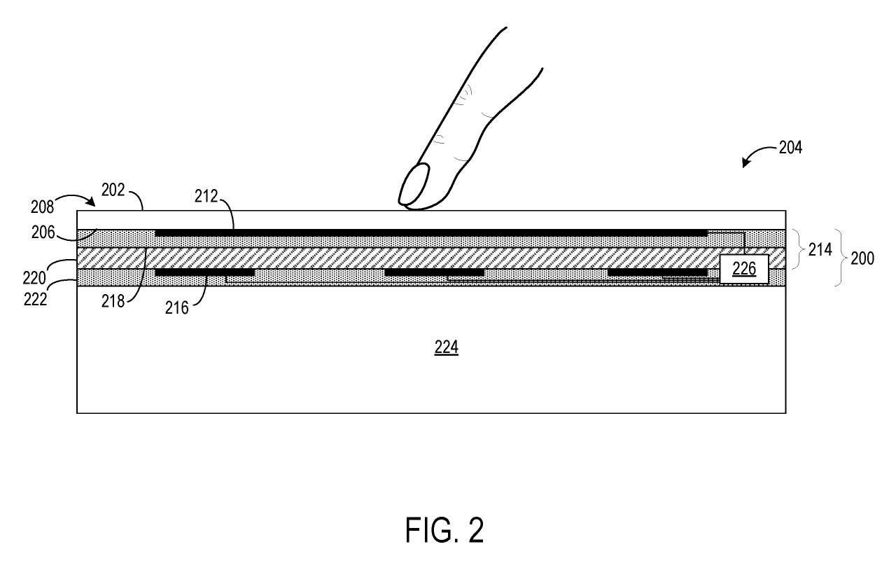

FIG. 2 schematically shows a sectional view of an example capacitive touch sensor 200 integrated with an outer fabric layer 202 of a device 204. The touch sensor 200 is one example of a touch sensor that may be used as the first sensor 114 and the second sensor 116 of FIG. 1. The touch sensor 200 is formed on an inner surface 206 of the outer fabric layer 202 of the device 204, allowing the touch sensor 200 to detect touches on an outer surface 208 of the outer fabric layer 202 while remaining out of view. In other examples, a touch sensor may be formed on an outer surface of a fabric layer of a device.

The outer fabric layer 202 may be formed from any suitable fabric material. Examples include woven and non-woven fabrics made of natural and/or synthetic fibers. Further, the outer fabric layer 202 may have any suitable thickness to allow the touch sensor 200 to detect touches through the outer fabric layer 202. In some examples, the outer fabric layer 202 may have a thickness in a range of 0.2 to 0.6 millimeters. In other examples, the outer fabric layer 202 may have any other suitable thickness, e.g., that is within a sensing distance of the touch sensor 200.

To help prevent absorption of a conductive ink deposited onto the fabric, the outer fabric layer 202 may include a coating, such as a polymer coating. In some examples, the threads of the outer fabric layer 202 may be coated before the outer fabric layer 202 is formed, while in other examples the coating may be applied after the outer fabric layer 202 has been formed. The coating may be formed from any suitable material. For example, the coating may comprise one or more of a polyurethane coating and a polyacrylate coating. In other examples, such as where the fabric fibers do not absorb an electrode ink to an unsuitable degree, the coating may be omitted.

The touch sensor 200 further includes a first electrode 212 disposed on the inner surface 206 of the fabric layer 202, a dielectric structure 214 disposed over the first electrode, and a second electrode 216 disposed on the dielectric structure 214. The first electrode 212 may be formed in any suitable manner. As an example, the first electrode 212 may be printed onto the outer fabric layer 202 using a conductive ink, examples of which are described below. Any suitable printing method may be used. Examples include, but are not limited to, screen printing and inkjet printing.

As mentioned above, due to the surface morphology of fabrics, it may be difficult to deposit a robust, curable resin-based dielectric layer onto the fabric, as the uneven surface morphology may require the use of a relatively thick dielectric layer to avoid forming defects that may present a shorting risk. As such, the dielectric structure 214 may be formed from a solid material that is applied to the fabric as a sheet, rather than as a resin that needs to be cured subsequent to deposition. The selection of a thin, smooth material may allow for the use of a thinner dielectric layer, while helping to avoid cracks, pores and other defects that may occur when using a curable dielectric material deposited on the fabric. Such a material also may present a flat, uniform surface for printing a second electrode layer.

The dielectric structure 214 may be coupled to the outer fabric layer 202 in any suitable manner. As one example, the dielectric structure 214 may take the form of a two-layer structure that includes an adhesive layer 218 that bonds the dielectric structure 214 to the outer fabric layer 202 and the first electrode 212, and also includes a thin, solid dielectric sheet, which is referred to herein as an electrode support layer 220. In some examples, the adhesive layer 218 of the dielectric structure 214 may take the form of a thermoplastic material having a lower melting point than the dielectric material of the electrode support layer 220. This may allow the dielectric structure 214 to be laminated or thermally adhered onto the outer fabric layer 202 by melting the adhesive layer 218 to bond to the outer fabric layer 202 without thermally degrading the electrode support layer 220. As one example, the adhesive layer may include a material such as ethylene vinylacetate (EVA), while the electrode support layer 220 may include a thin sheet of polypropylene, polyethylene terephthalate, a polyamide, polyimide and/or other suitable dielectric materials or combinations thereof. In other examples, the dielectric structure 214 may use one or more of a pressure sensitive adhesive or a curable adhesive as the adhesive layer 218.

The second electrode 216 is formed on the electrode support layer 220 of the dielectric structure 214. As mentioned above, one or both of the first electrode 212 and the second electrode 216 may be printed. In such examples, the first electrode 212 may be printed across an area of the outer fabric layer 202 and the second electrode 216 may be printed to form a capacitive junction with the first electrode 212 at corresponding touch sensing locations. It will be understood that a plurality of similar electrodes may be printed to form a sensing array. Where one but not both conductive materials are printed, the other conductive material may take the form of a fiber sewn, woven, laminated, adhered, or otherwise integrated with the fabric, for example.

Any suitable conductive ink may be used to form the electrodes. In some examples, the conductive ink used may have a relatively high viscosity, for example greater than 40 Pascal seconds, and may also have a relatively high surface tension. Such a high-viscosity, high-surface-tension ink may help to reduce a risk of the ink penetrating through the outer fabric layer 202 as compared to lower viscosity inks. Examples of suitable conductive inks that may be used to print the first electrode 212 include inks comprising metal particles such as silver, carbon, copper, and nickel. As a more specific example, a silver-urethane ink may be used. Such an ink may be highly conductive, highly flexible, and may be formulated to have a viscosity of approximately 40 Pascal seconds. Various components of the conductive ink may be appropriately selected to tune for desired characteristics, including the ink formula, mass loading of the conductive particles, the type of resin(s), solvent selection and concentration, surfactants, etc.

Continuing with FIG. 2, an additional insulating layer, such as encapsulant layer 222, may be formed over the second electrode 216 of the touch sensor 200. The additional encapsulant layer 222 may be formed from any suitable material, which may be selected based upon an intended end use, and may be omitted in some examples. The outer fabric layer 202 with the touch sensor 200 maybe mounted onto a device chassis 224 or other suitable device structure, via an adhesive or in any other suitable manner. The device 204 may represent a computing device, such as the handheld computing device 100, or any other suitable article or object. Examples of various devices are described in more detail below.

Each electrode of the touch sensor 200 is connected to a controller 226 configured to sense touch via the electrodes 212, 216. Further, in some examples, a device on which a touch sensor is located may have an outer casing of a metal material or other conductive material. In such examples, a first electrode may be disposed on the outer fabric layer of the device, and the casing may serve as the second electrode, thereby allowing the printing of the second electrode to be omitted.

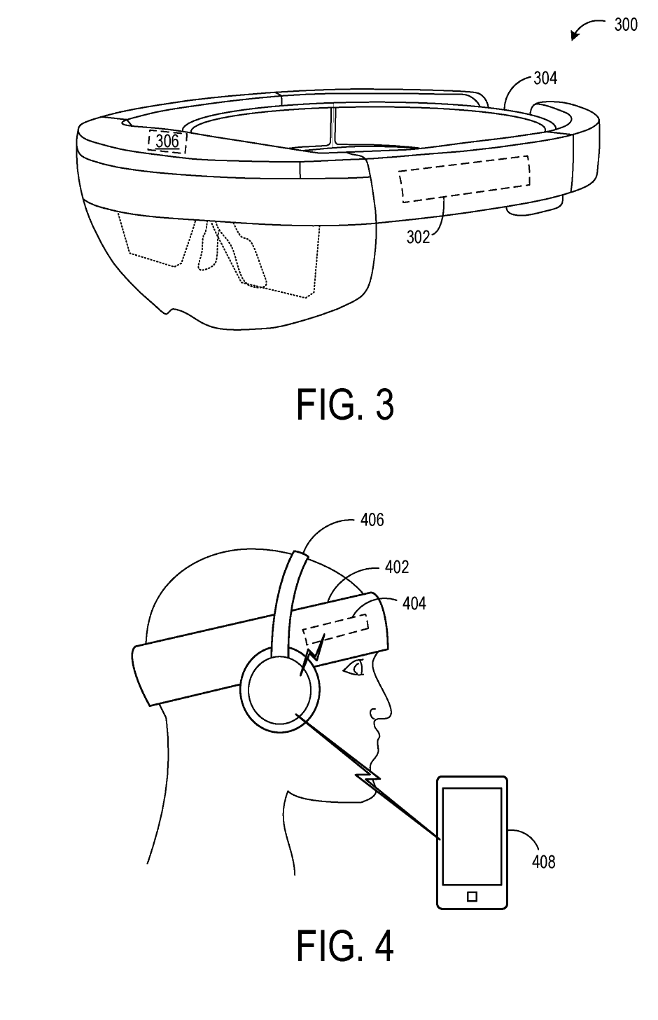

The example touch sensor of FIG. 2 may be used in a variety of different contexts. FIG. 3 shows an example computing device in the form of a head-mounted display device 300 that includes a touch sensor 302. The head-mounted display device 300 includes an adjustable band 304 that supports various components configured to present mixed reality imagery to a wearer. For comfort and/or design considerations, the adjustable band 304 may include an outer layer of soft, deformable, and/or flexible material, such as fabric or an elastomeric material. Thus, the adjustable band 304 may incorporate a touch sensor 302 in the fabric of the band. The touch sensor 302 may be used to detect various touch inputs and touch gestures from a wearer touching the outer surface of the adjustable band 304 at the location of the touch sensor 302. Detected touch signals may be delivered to the controller 310 to perform actions on the head-mounted display device 300, such as to control a virtual cursor, scroll through settings or displayed imagery, adjust volume of audio output, and/or perform a selection of a displayed element.

A touch sensor also may be used to provide outputs to a remotely-located computing device via a wired or wireless connection. FIG. 4 illustrates an example wearable item in the form of a headband 402 that has a touch sensor 404 configured to detect touch inputs from a user. The user is also wearing a set of headphones 406 that may stream audio content communicated from a portable computing device 408. Touch inputs received by the touch sensor 404 may be used, for example, to control a volume level of audio streaming on the headphones 406, or to input track selections, to turn mute on/off, etc. As such, the headband 402 may provide the user with a convenient way to perform actions of the headphones 406 without having to pick up or use the portable computing device 408.

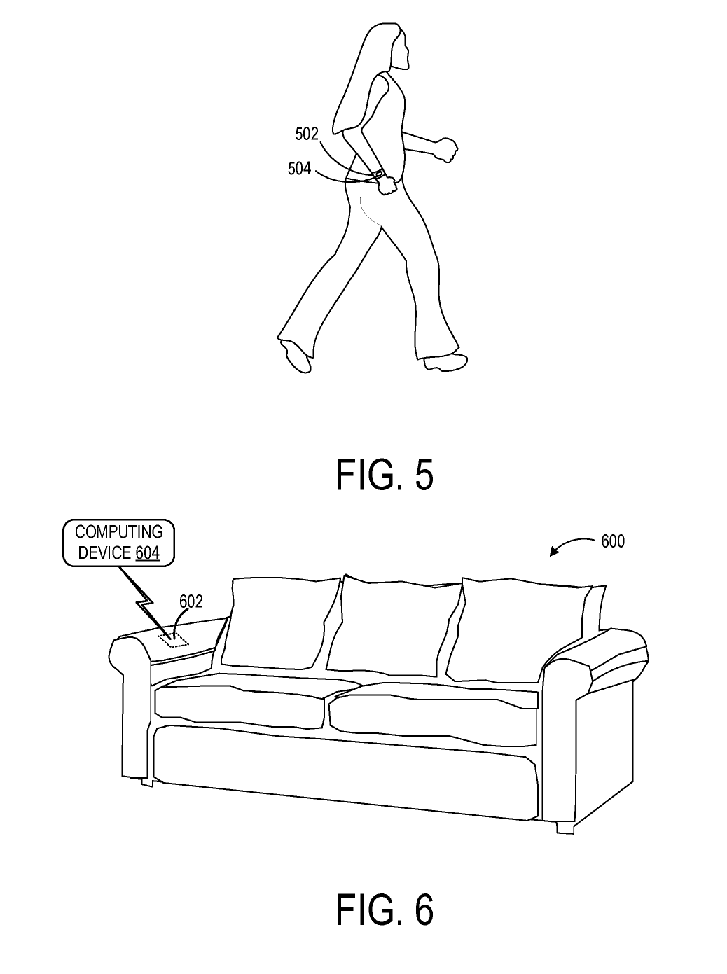

In some examples, a touch sensor integrated into a wearable device may also be configured to interface with or be additionally implemented as other sensors on the wearable device. FIG. 5 shows an example wearable computing device 502 in the form of a wristband that includes an integrated touch sensor 504. The touch sensor 504 may be configured to detect swipes or other touch gestures on an exterior of the wearable computing device 502, allowing a user to browse through applications of the wearable computing device 502, adjust settings (e.g. volume, exercise metrics), and provide other suitable functions. The touch sensor 504 also may allow a user to control a device paired (e.g. wirelessly) with the wearable computing device 502, such as a smart phone (not shown).

The wearable computing device 502 may include a variety of other devices, such as galvanic skin response (GSR) sensors, heart rate sensors, temperature sensors, and other suitable biometric sensors that may be used to monitor conditions of the user. In addition to touch sensor 504, various other sensors may be formed by printing electrodes onto a fabric layer. For example, a GSR sensor may be embedded or printed onto fabric that is configured to contact the skin of a user. Further, a heart rate sensor, for example, may be implemented as two electrodes (and possibly a third reference electrode) configured to measure resistance or capacitance across an area of skin between the two electrodes. As yet another example, an electrochemical sensor may be printed onto a fabric substrate. Such a sensor may include, for example, a plurality of electrodes, one of which is coated with an analyte-selective enzyme that undergoes a redox reaction when contacted by the analyte (e.g. across an ion-selective barrier between the sensor and the skin).

FIG. 6 shows an example furniture item 600 that incorporates a touch sensor 602. The touch sensor 602 may be configured to communicate with a computing device 604, such as a television, desktop computer, or other media presentation device. For example, the touch sensor 602 may be configured to provide input to select channels, adjust volume, etc. of a television device, and/or to control other devices, in communication with a computing device with which a controller of the touch sensor 602 is paired (e.g. home electronics such as a thermostat, lighting controls and/or appliances).

It will be understood that a touch sensor as disclosed herein may be used in any other suitable fabric-containing devices or items, such as articles of clothing, vehicle upholstery, and bedding.

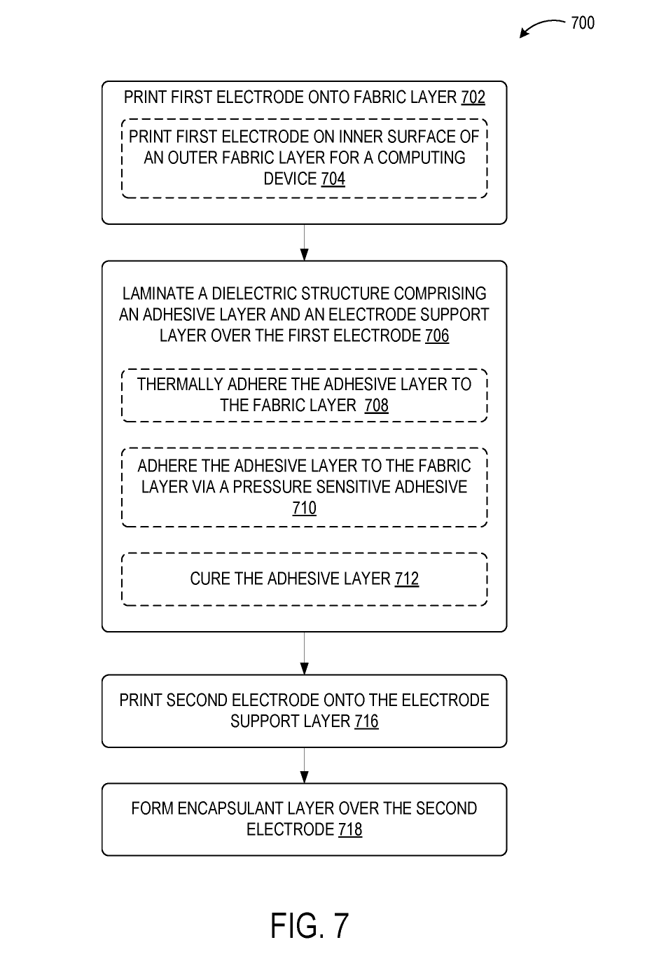

FIG. 7 shows an example method 700 of forming a touch sensor. The method 700 includes, at 702, printing a conductive ink onto a fabric layer to form a first electrode. In some examples, the first electrode may be printed on an inner surface of an outer fabric layer of a computing device, at 704. In other examples, the first electrode may be printed onto an outer surface of the fabric.

The method 700 further includes laminating a dielectric structure over the first electrode, at 706. In some examples, the dielectric structure includes an adhesive layer that bonds the dielectric structure to the fabric layer and the first electrode and also include an electrode support layer. In such examples, laminating the dielectric structure may include first positioning the dielectric structure on the fabric and first electrode, and then thermally adhering the adhesive layer, at 708, adhering via a pressure sensitive adhesive, at 710, or curing the adhesive layer, at 712. In other examples, the adhesive may be applied as a separate layer prior to applying the electrode support layer. After laminating the dielectric structure, the method 700 further includes printing the second electrode onto the electrode support layer, at 716, and optionally forming an encapsulant layer over the second electrode 718. The fabric comprising the touch sensing structure may then be mounted onto any suitable device surface.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 8 schematically shows a non-limiting embodiment of a computing system 800 that can enact one or more of the methods and processes described above. The computing system 800 is shown in simplified form. The computing system 800 may take the form of one or more personal computers, server computers, tablet computers, home-entertainment computers, network computing devices, gaming devices, mobile computing devices, mobile communication devices (e.g., smart phone), and/or other computing devices. The computing system 800 is a non-limiting example of hand-held computing device 100, computing device 204, head-mounted display device 300, computing device 406, computing device 506, and computing device 604.

The computing system 800 includes a logic machine 802 and a storage machine 804. The computing system 800 may optionally include a display subsystem 806, input subsystem 808, sensor subsystem 810, communication subsystem 812 and/or other components not shown in FIG. 8.

The logic machine 802 includes one or more physical devices configured to execute instructions. For example, the logic machine 802 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 802 may include one or more processors configured to execute software instructions. Additionally or alternatively, the logic machine 802 may include one or more hardware or firmware logic machines configured to execute hardware or firmware instructions. Processors of the logic machine 802 may be single-core or multi-core, and the instructions executed thereon may be configured for sequential, parallel, and/or distributed processing. Individual components of the logic machine 802 optionally may be distributed among two or more separate devices, which may be remotely located and/or configured for coordinated processing. Aspects of the logic machine 802 may be virtualized and executed by remotely accessible, networked computing devices configured in a cloud-computing configuration.

The storage machine 804 includes one or more physical devices configured to hold instructions executable by the logic machine 802 to implement the methods and processes described herein. When such methods and processes are implemented, the state of the storage machine 804 may be transformed—e.g., to hold different data.

The storage machine 804 may include removable and/or built-in devices. The storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The storage machine 804 may include volatile, nonvolatile, dynamic, static, read/write, read-only, random-access, sequential-access, location-addressable, file-addressable, and/or content-addressable devices.

It will be appreciated that the storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of the logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, the display subsystem 806 may be used to present a visual representation of data held by the storage machine 804. This visual representation may take the form of a graphical user interface (GUI). As the herein described methods and processes change the data held by the storage machine 804, and thus transform the state of the storage machine 804, the state of the display subsystem 806 may likewise be transformed to visually represent changes in the underlying data. The display subsystem 806 may include one or more display devices utilizing virtually any type of technology. Such display devices may be combined with the logic machine 802 and/or the storage machine 804 in a shared enclosure, or such display devices may be peripheral display devices.

When included, the input subsystem 808 may comprise or interface with one or more user-input devices such as a keyboard, mouse, touch screen, or game controller. In some embodiments, the input subsystem 808 may comprise or interface with selected sensors of the sensor subsystem 810, such as natural user input (NUI) componentry. Such componentry may be integrated or peripheral, and the transduction and/or processing of input actions may be handled on- or off-board. Example NUI componentry included in the sensor subsystem 810 may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity. The sensor subsystem 810 may include one or more touch sensors 114, 116, 200, 302, 408, 504, and 602 described above.

When included, the communication subsystem 812 may be configured to communicatively couple computing system 800 with one or more other computing devices. The communication subsystem 812 may include wired and/or wireless communication devices compatible with one or more different communication protocols. As non-limiting examples, the communication subsystem 812 may be configured for communication via a wireless telephone network, or a wired or wireless local- or wide-area network. In some embodiments, the communication subsystem 812 may allow the computing system 800 to send and/or receive messages to and/or from other devices via a network such as the Internet.

Another example provides a touch sensor, comprising a fabric layer, a first electrode comprising a conductive ink disposed on the fabric layer, a dielectric structure disposed over the first electrode, the dielectric structure comprising an electrode support layer and an adhesive layer bonding the electrode support layer to the fabric layer and the first electrode, and a second electrode disposed on the electrode support layer. The fabric layer may additionally or alternatively include one or more of a polyurethane coating and a polyacrylate coating. The fabric layer may additionally or alternatively include a woven fabric. The adhesive layer may additionally or alternatively include a material with a lower melting point than the electrode support layer. The adhesive layer may additionally or alternatively include one or more of a pressure sensitive adhesive and a curable adhesive. The electrode support layer may additionally or alternatively include one or more of polypropylene, polyethylene terephthalate, a polyimide and a polyamide. The ink may additionally or alternatively include silver particles. The touch sensor may additionally or alternatively include an insulating layer formed over the second electrode. The touch sensor may additionally or alternatively be incorporated into an outer fabric layer of a computing device.

Another example provides a computing device, comprising an outer fabric layer comprising an outer surface and an inner surface, and a sensor arranged on the inner surface of the outer fabric layer to sense a touch made to the outer surface of the outer fabric layer, the sensor comprising a first electrode formed on the inner surface of the outer fabric layer. The computing device may additionally or alternatively include a handheld device. Where the sensor may additionally or alternatively be a left-hand touch sensor, the touch sensor may additionally or alternatively include a right-hand touch sensor also formed on the inner surface of the outer fabric layer. The sensor may additionally or alternatively be a first sensor of an array of sensors configured to detect one or more of multiple touch locations and touch gestures. The computing device may additionally or alternatively include a wearable device, and wherein the outer fabric layer may additionally or alternatively be an outer layer of a band of the wearable device. The sensor may additionally or alternatively include a dielectric structure disposed over the first electrode, an electrode support layer and an adhesive layer bonding the electrode support layer to the outer fabric layer and the first electrode, and a second electrode disposed on the electrode support layer. The adhesive layer may additionally or alternatively include a material having a lower melting point than a material of the electrode support layer.

Another example provides a method of forming a touch sensor, the method comprising printing a first electrode onto a fabric layer, laminating a dielectric structure over the first electrode, the dielectric structure comprising an adhesive layer that bonds the dielectric structure to the fabric layer and the first electrode and also comprising an electrode support layer, and printing a second electrode onto the dielectric support layer. Laminating the dielectric structure over the first electrode may additionally or alternatively include thermally adhering the adhesive layer to the fabric layer. Laminating the dielectric structure over the first electrode may additionally or alternatively include adhering the adhesive layer to the fabric layer via a pressure sensitive adhesive. Laminating the dielectric structure over the first electrode may additionally or alternatively include curing the adhesive layer.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A touch sensor, comprising:
a fabric layer;
a first electrode comprising a conductive ink disposed on the fabric layer;
a dielectric structure disposed over the first electrode, the dielectric structure comprising an electrode support layer and an adhesive layer bonding the electrode support layer to the fabric layer and the first electrode; and
a second electrode disposed on the electrode support layer.

2. The touch sensor of claim 1, wherein the fabric layer comprises one or more of a polyurethane coating and a polyacrylate coating.

3. The touch sensor of claim 1, wherein the fabric layer comprises a woven fabric.

4. The touch sensor of claim 1, wherein the adhesive layer comprises a material with a lower melting point than the electrode support layer.

5. The touch sensor of claim 1, wherein the adhesive layer comprises one or more of a pressure sensitive adhesive and a curable adhesive.

6. The touch sensor of claim 1, wherein the electrode support layer comprises one or more of polypropylene, polyethylene terephthalate, a polyimide and a polyamide.

7. The touch sensor of claim 1, wherein the ink comprises silver particles.

8. The touch sensor of claim 1, further comprising an insulating layer formed over the second electrode.

9. The touch sensor of claim 1, wherein the touch sensor is incorporated into an outer fabric layer of a computing device.

10. A computing device, comprising:
an outer fabric layer comprising an outer surface and an inner surface; and
a sensor arranged on the inner surface of the outer fabric layer to sense a touch made to the outer surface of the outer fabric layer, the sensor comprising a first electrode formed on the inner surface of the outer fabric layer.

11. The computing device of claim 10, wherein the computing device comprises a handheld device.

12. The computing device of claim 11, wherein the sensor is a left-hand touch sensor, and further comprising a right-hand touch sensor also formed on the inner surface of the outer fabric layer.

13. The computing device of claim 11, wherein the sensor is a first sensor of an array of sensors configured to detect one or more of multiple touch locations and touch gestures.

14. The computing device of claim 10, wherein the computing device comprises a wearable device, and wherein the outer fabric layer comprises an outer layer of a band of the wearable device.

15. The computing device of claim 10, wherein the sensor further comprises a dielectric structure disposed over the first electrode, an electrode support layer and an adhesive layer bonding the electrode support layer to the outer fabric layer and the first electrode, and a second electrode disposed on the electrode support layer.

16. The computing device of claim 15, wherein the adhesive layer comprises a material having a lower melting point than a material of the electrode support layer.

17. A method of forming a touch sensor, the method comprising:
printing a first electrode onto a fabric layer;
laminating a dielectric structure over the first electrode, the dielectric structure comprising an adhesive layer that bonds the dielectric structure to the fabric layer and the first electrode and also comprising an electrode support layer; and
printing a second electrode onto the dielectric support layer.

18. The method of claim 17, wherein laminating the dielectric structure over the first electrode comprises thermally adhering the adhesive layer to the fabric layer.

19. The method of claim 17, wherein laminating the dielectric structure over the first electrode comprises adhering the adhesive layer to the fabric layer via a pressure sensitive adhesive.

20. The method of claim 17, wherein laminating the dielectric structure over the first electrode comprises curing the adhesive layer.
